(19) United States
(12) Patent Application Publication
(10) Pub. No.: US 2020/0410435 A1
(43) Pub. Date: Dec. 31, 2020

(54) METHOD AND CAMERA SYSTEM FOR MONITORING A PICKING OR PACKAGING PROCESS

(71) Applicant: Robert Bosch GmbH, Stuttgart (DE)

(72) Inventors: Darno Alexander Ketterer, Renningen (DE); Ulrich Selinger, Karlsruhe (DE); Michael Findeis, Markgroeningen (DE); Andreas Doering, Frankfurt/M. (DE); Mark Luehrs, Waghaeusel (DE)

(21) Appl. No.: 16/978,973

(22) PCT Filed: Mar. 1, 2019
(86) PCT No.: PCT/EP2019/055191

§ 371 Date: Sep. 8, 2020

(30) Foreign Application Priority Data
Mar. 12, 2018 (DE) 10 2018 203 645.4

(51) Int. Cl. G06Q 10/08; B65B 57/18; G06K 7/14

(52) U.S. Cl. CPC G06Q 10/087; G06K 7/1413; B65B 57/18

(57) ABSTRACT

A method for monitoring a picking or packaging process of at least one article. Using a plurality of cameras, images are recorded of at least one moving article. Labels in the images are read. The read labels are compared with specifications from a picking list, and a sort of the article is identified on the basis of the comparison. If the sort of the article does not agree with specifications from the picking list, a warning is issued. In addition, a camera system having a plurality of cameras is provided. These cameras are set up to record at least the images and to read labels in the images.

### FIELD

The present invention relates to a method for monitoring a picking or packaging process of at least one article. In addition, the present invention relates to a computer program that is set up to carry out steps of the method according to the present invention, as well as to a machine-readable storage medium on which the computer program is stored. In addition, the present invention relates to a camera system that is set up to carry out steps of the method according to the present invention. Finally, the present invention relates to an electronic control device that is set up to monitor a picking or packaging process of at least one article using the method, as well as to a monitoring system for monitoring a picking or packaging process, having a camera system and an electronic control device.

### BACKGROUND INFORMATION

In a distribution center, at stationary work stations, packaged articles are packaged in transport units by employees. The packaged articles must be entered into a WMS (Warehouse Management System), with product number, quantity, and further information.

For this purpose, the employee identifies the article and the packaging quantity by visually inspecting the label. If the product number is present on the label as a barcode, then the barcode is acquired using a hand scanner, instead of visually.

Subsequently, the employee manually counts the number of packagings of this article, and enters the quantity in the WMS. If additional information, such as manufacturing date, batch number, or serial number, is to be acquired, this information is read from the label by the employee and is also entered in the WMS. Individually, this information is given on a separate barcode on the label that can be acquired by a hand scanner. This manual acquisition of information concerning the packaged articles in the WMS represents a large part of the overall work that goes into the packaging of articles for transport.

Following the identification and the counting, the employee packages the products into the shipping unit. This step is not further acquired in the WMS. Because the packaging process is the final step in the supply chain, errors that occur due to human acquisition of the data, such as quantity errors (oversupplying or undersupplying) and identification errors (supplying the wrong product) are first discovered only by the customer.

When reading from the label, on the one hand information coded in a barcode or a QR code can be acquired. On the other hand, text on a label can also be read using text recognition (OCR,

Optical Character Recognition). In order to compensate problems such as a dirty label, low contrast between the label background and the printing, or poor illumination, German Patent Application No. DE 10 2016 201 383 A1 described, for example, to use a method for preprocessing digital data in a text recognition system. There, an image segment is digitally scanned, at least one point of the image segment is digitally acquired, and a contrast characteristic variable of the point is modified. A digital filter may be used for this purpose.

### SUMMARY

In accordance with an example embodiment of the present invention, in a method for monitoring a picking or packaging process of at least one article, a plurality of images are recorded of at least one moving article, using a plurality of cameras, in particular using at least 3 cameras. Through the use of a plurality of cameras, these images of the article can be recorded from various angles. In addition, because the images are recorded while the article is in motion, they are acquired at different positions of the article. Here the cameras are preferably set up each to record at least up to 30 images per second, in order to enable acquisition of a large quantity of data during the movement of the article. The movement of the article can be accomplished in that a logistics employee moves the article through the recording field of the camera.

One or more labels in the images are read. Here, it can be provided both to read individual images and also to place a plurality of images one over the other. In the latter case, the clearest and sharpest images yield a new image in which the label is then easily recognizable. For this purpose, in particular a method may be used as is described in German Patent

Application No. DE 10 2016 201 389 A1. All identifiable information is read, including both one-dimensional and two-dimensional barcodes as well as QR codes, and also texts and graphic logos. The read labels are compared with specifications from a picking list that contains the sort of article with its identifying features, possible packaging units, and the quantity of the article to be picked. On the basis of the result of this comparison over all recognized identification features of the article, a sort of the article is identified. Here, the sort is understood as the type of article, but not its number. If this sort of the article does not agree with specifications from the picking list, i.e., if it is an article that is not to be packaged in the current picking or packaging process, then a warning is issued, for example by an electronic control device.

In the context of the present invention, a picking list can be understood as a list stored on a storage unit, in particular a list stored in the form of a data file. The data file having the list can for example be stored on a computing device such as a computer or a server or a cloud computing system.

In accordance with the present invention, it is preferred that the cameras use a recognition method based on which images are recorded only when an article is in the recording field of the camera. In this way, the number of images from which labels have to be read is reduced.

However, even using this measure, a large number of images are recorded that do not contain a label or in which a label is only incompletely contained, because the label is either not visible from the recording angle of a camera in its current position, or because it is for example covered by a hand of the logistics employee. Therefore, it is additionally preferred that, between the recording of the images and the reading of the label, a selection is made of all images that contain at least one label and have at least a prespecified image quality for further processing. The image quality can be determined for example by the sharpness of the image as well as by the size of the recognized label in the image. Each image is evaluated on the basis of the named criteria, and images are selected starting from a threshold value that can be set. The reading is then carried out only with the selected images.

If a label can be read, but a plurality of items of information having various levels of quality are acquired, then it can preferably additionally be provided to assign a confidence level to each item of information, and to carry out a weighting of the information according to its confidence level. Incompletely read labels can in this way be removed by sorting, based on their low confidence level.

If, when comparing the read label with the specification from the picking list, it is recognized that an article or a group of articles moved together has a plurality of labels that are assigned to different sorts of articles, then an unambiguous identification of the article sort is not possible. This may happen for example if articles of different sorts have accidentally been moved at the same time. In this case, it is preferable to issue a warning so that a manual identification of the article can be made.

If an article has a plurality of labels that are suitable to identify it, then in principle in the method it is sufficient to read only one of these labels. This increases the probability of successful identification of the article. However, in order to achieve a particularly high degree of reliability of the identification, it can also be provided that one or more labels of an article are marked as essential labels in the picking list. If the sort of an article is successfully identified, but on the basis of the picking list it is recognized that this article is supposed to have an essential label that was not read, then in this specific embodiment of the method a warning is issued in order to repeat the method once again for this article, or to carry out a manual check.

Preferably, after placing the article in a transport container, at least one image and at least one depth measurement of the article are recorded. One or more cameras can be situated over the transport container in order to record the image. The depth measurement enables a three-dimensional acquisition and measuring of the article whose image was recorded. If a plurality of articles are stored at different locations in the package, then this can also be recognized through the recording of the image and the depth measurement. In a specific embodiment of the method, the camera used to record the image is realized as a depth camera. In another specific embodiment, a laser is provided as depth sensor, which can be installed directly in the camera or can also be positioned locally outside it.

From the recorded data, the three-dimensional dimensions of the article are calculated. These dimensions are compared with specifications that are stored in the picking list for the identified sort of the article. The specifications correspond to the dimensions of a single packaged article. A warning is issued if the dimensions of the article do not agree with the specifications from the picking list, or with a multiple of the specifications. Here, a multiple of the specifications indicates that either the logistics employee took a plurality of articles simultaneously and placed them in the transport container, or that a plurality of articles were bundled together by an outer packaging. However, if the calculated dimensions correspond neither to the specified dimensions of an individual article nor to those of a plurality of individual articles or of a defined outer packaging, then the acquired data are not plausible and a warning is issued so that a manual check can take place.

In addition, it is preferred that, from the comparison of the dimensions with specifications from the picking list, a number of articles placed into the transport container is inferred. This enables an automated accompanying counting of the articles placed in the transport container. Particularly preferably, a warning is issued if the number of all articles already acquired in the method that are of the same sort is greater than a specification from the picking list with regard to the number to be packaged of this sort of article. In this way, the shipping employee is informed that she or he has placed the correct article in the container, but that too many of them were placed therein, and that the excess article or articles have to be removed from the transport container.

In accordance with an example embodiment of the present invention, the computer program is set up to carry out at least the comparison of the read label, the identification of the sort of the article, and the issuing of the warning if the article sort does not agree with the specifications from the picking list, when it is executed on a computing device or electronic control device. In principle, the recording of the images and the reading of the labels can also be controlled by the computer program. However, it is alternatively also possible for these steps of the method to be carried out in separate computing units in the camera that is used.

Preferably, the computer program is in addition set up to carry out the comparison of the dimensions and the issuing of a warning if the dimensions of the article do not agree with the specifications from the picking list and a multiple of the specifications. In principle, the computer program can also carry out the recording of the image and the depth measurement of the article, as well as the calculation of its three-dimensional dimensions from these data. Alternatively, however, these steps can also be done externally in separate computing units that are parts of cameras or depth sensors.

The computer program enables the implementation of different specific embodiments of the method on a computing device or electronic control device without having to make constructive changes thereto. For this purpose, it is stored on the machine-readable storage medium.

The camera system has a plurality of cameras that are set up to carry out at least the recording of images at least of a moved article, and the reading of labels in the images. Such a camera system makes it possible to carry out steps of the method outside a central computing device or electronic control device, and in this way, through the preprocessing of images, to reduce demands on bandwidth and latency of a network that is used, and to increase the transmission speed. This additionally enables the use of high image rates that increase the identification rate of the article sort. In particular, the camera system is a system that is set up for image preprocessing and postprocessing. While preprocessing can include for example functions for filtering and pre-sorting images, postprocessing includes for example functions for image optimization, character recognition, distortion and moiré optimization, and for adjusting resolution, image size, and image format.

Preferably, the camera system has at least one camera that has a depth sensor and is set up to record the at least one image and to carry out the at least one depth measurement of the article after its placement in the transport container, and to calculate its three-dimensional dimensions. This enables an additional relocation of method steps outside the central computing device or electronic control device.

In accordance with an example embodiment of the present invention, the electronic control device is set up to monitor a picking or packaging process of articles using the method. Not all method steps need be carried out in the electronic control device itself. If some method steps are carried out in the camera system, then the electronic control device merges only the information from the carried-out method steps, and in particular carries out the still-missing method steps using the computer program.

In accordance with an example embodiment of the present invention, the monitoring system for monitoring a picking or packaging process of at least one article has a camera system having at least one camera that has a depth sensor and that is set up to carry out the at least one image and the at least one depth measurement of the article after its placement in the transport container and to calculate its three-dimensional dimensions, as well as an electronic control device that is set up to monitor a picking or placement process of articles using the method.

However, the method can also be carried out without using a central electronic control device. In this case, the computer program is executed for example in a cloud.

### BRIEF DESCRIPTION OF THE DRAWINGS

Exemplary embodiments of the present invention are shown in the figures and are explained in more detail in description below.

FIG. 1 shows a schematic representation of a picking work station at which a method according to an exemplary embodiment of the present invention can be carried out.

FIG. 2 shows, in a schematic side view, a plurality of articles whose picking process can be monitored using a method according to an exemplary embodiment of the present invention, and that are contained in a outer packaging.

FIG. 3 shows the outer packaging of FIG. 2, from which an article has been removed.

FIG. 4 shows a flow diagram of a method according to an exemplary embodiment of the present invention.

FIG. 5 schematically shows another picking work station at which a method according to an exemplary embodiment of the present invention can be carried out.

FIG. 6 shows a flow diagram of another exemplary embodiment of the method according to the present invention.

### DETAILED DESCRIPTION OF EXAMPLE EMBODIMENTS

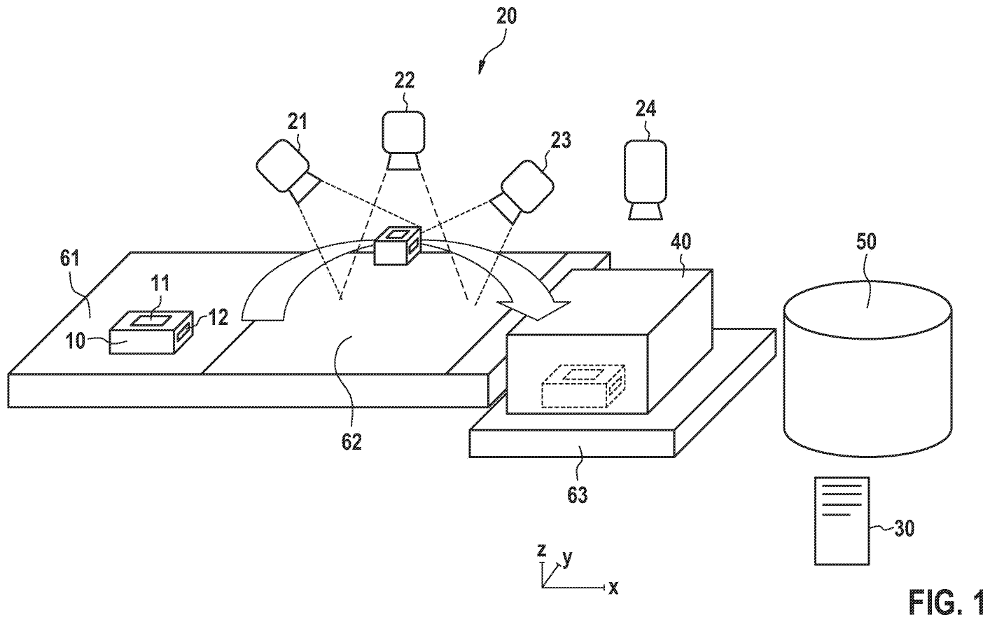

At a picking work station shown in FIG. 1, an article 10 is to be packaged. Article 10 has a first label 11 on the upper side of its packaging, and a second label 12 is attached to one of the side surfaces of its packaging. For the monitoring of the picking process, a camera system 20 is provided that is made up of four cameras 21 through 24. The first three cameras 21, 22, 23 are industrial cameras that are capable of recording up to 30 images per second, while fourth camera 24 is a depth camera. In a picking list 30, it is stated which sorts of articles 10, and which quantities of these articles, are to be packaged in a transport container 40. Picking list 30 is read in in an electronic control device 50 that controls the camera system. The picking work station has a placement area 61 on which articles 10 can be put down before the packaging process. The first three cameras 21, 22, 23 are situated above a read area 62. A shipping employee takes each article 10 to be packaged from placement area 61, moves it through read area 62, and places it in transport container 40. Transport container 40 is situated in a lower-positioned transport area 63 above which fourth camera 24 is positioned. When article 10 is moved through read area 62, it reaches the record area of the first three cameras 21, 22, 23. When article 10 is placed in transport container 40, it is situated in the record area of fourth camera 24.

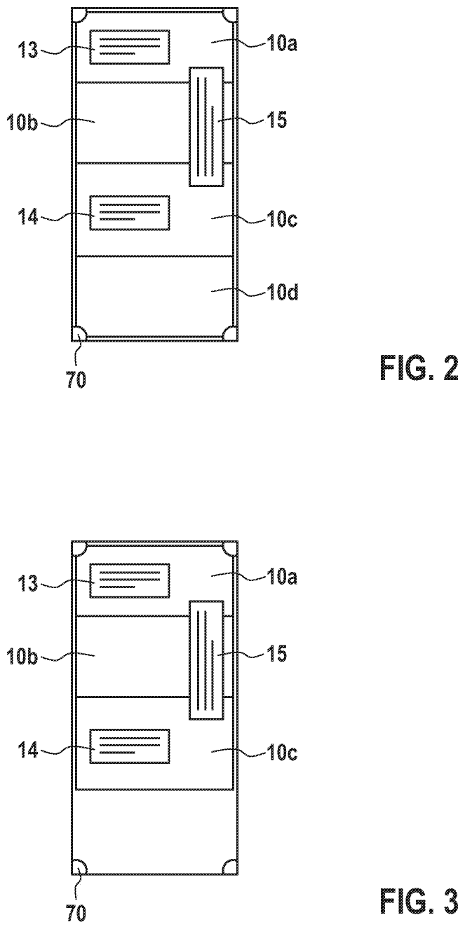

A plurality of articles 10a, 10b, 10c, 10d can be bundled by an outer packaging 70. Outer packaging 70 is made of a transparent film. From a side of outer packaging 70, shown in FIG. 2, individual labels, such as label 13 of article 10a and label 14 of article 10c, may be visible. The labels of the further articles 10b, 10d are not visible from this direction. However, a further label 15 is visible that is not attached to the articles themselves, but rather is attached to outer packaging 70, where it again indicates the type of article and also the number of articles contained in outer packaging 70, i.e., four.

Sometimes, individual articles are removed from outer packagings 70. FIG. 3 shows outer packaging 70 of FIG. 2 from which the lowermost article 10d has been removed. The label on outer packaging 70 now still indicates the correct sort of article in outer packaging 70, but no longer indicates the correct number of articles.

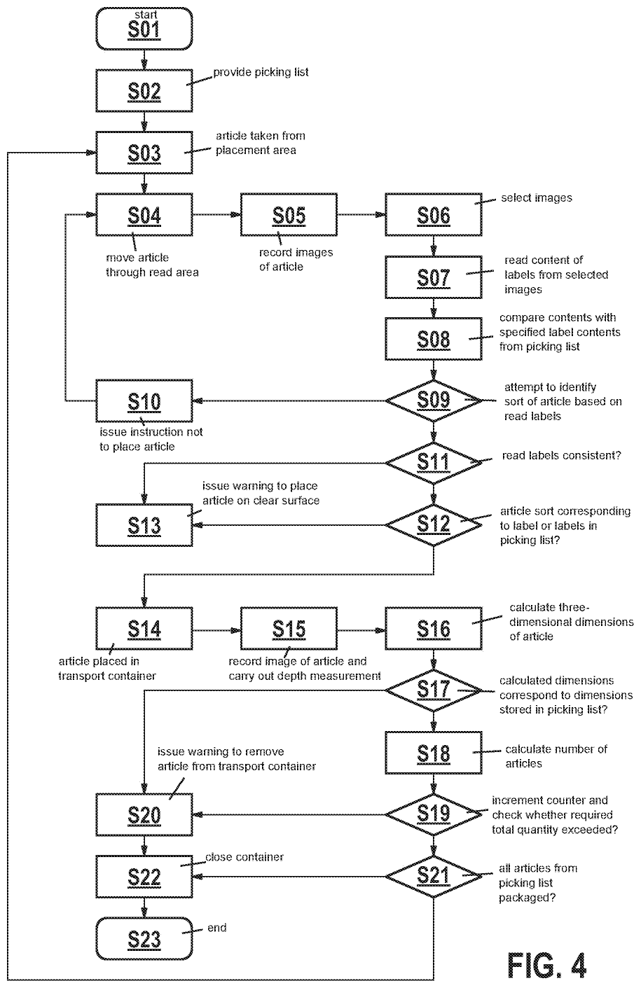

In an exemplary embodiment of the method according to the present invention shown in FIG. 4, method steps are carried out by a shipping employee, by camera system 20, and by electronic control device 50. In order to illustrate this division of work tasks, in FIG. 4 the method steps are grouped in three columns, the left column showing the method steps of the shipping employee, the center column showing the method steps of camera system 20, and the right column showing the method steps of electronic control device 50. The shipping employee starts the method in a step S01 by inputting, at a user interface of electronic control device 50 (not shown in FIG. 1), that a packaging process is to be started. Then, using another interface (not shown) of electronic control device 50, the employee reads in picking list 30, which is provided to electronic control device 50 in digital form (step S02). In a further step S03, the shipping employee takes an article 10 from placement area 61 and, in a step S04, moves it through read area 62. Here, in a step S05, images of article 10 are recorded by the first three cameras 21, 22, 23 of camera system 20, and these images are forwarded to electronic control device 50. In electronic control device 50, in a step S06 all the images are selected in which at least one label is completely contained and whose sharpness has a specified minimum value. From these images, in a step S07 the content of the labels is read, and in a step S08 the contents are compared with specified label contents from picking list 30. In a step S09, an attempt is made to identify a sort of article 10 on the basis of the read labels. If this is not successful, because no single label could be successfully read, an instruction is issued to the shipping employee not to place the article, in a step S10, into the transport container, but rather to move it again through read area 62 in step S04. This instruction is also issued when a label was read that can be assigned to an article contained in picking list 30, but according to picking list 30 this article would further require an essential label that was not read. Next, in a step S11 it is checked whether the read labels are consistent, i.e., whether they are all to be assigned to the same article according to picking list 30. Labels 11, 12, 13, 14, attached to a single article, are here considered to be consistent in relation to a label 15 on an outer packaging 70 as long as they all relate to the same sort of article. In a step S12 it is checked whether the article sort corresponding to the label or labels is contained in picking list 30. If one of the conditions of steps S11 or S12 is not met, then a warning is issued to the shipping employee, and the employee is asked to place the article 10 onto a clear surface, in a step S13. If no warning has been issued, then the shipping employee places article 10 into the transport container 40, in a step S14. There, using fourth camera 24 an image that shows the upper side of article 10 is recorded, and a depth measurement of article 10 is carried out, S15. This information is sent to electronic control device 50, and this device calculates, in a step S16, the three-dimensional dimensions of article 10, designated x, y, z in FIG. 1. In a step S17 it is checked whether dimensions x, y, z correspond to the dimensions of article 10 stored in picking list 30, or to a multiple of these dimensions. If this is the case, then in a step S18 the number of articles 10 placed in transport container 40 is calculated. In control device 50, a counter for the type of this article is correspondingly incremented upward, and in a step S19 it is checked whether a required total quantity of this article sort was exceeded by placing article or articles 10 in transport container 40. If this is the case, or if in step S17 it was already recognized that the dimensions x, y, z do not match the article sort ascertained from the labels, then a warning is issued to the shipping employee so that he or she will remove the article from transport container 40 and place it on a clear surface, S20. If no warnings have been issued, then in a step S21 it is checked whether all articles from picking list 30 have been packaged. If this is not the case, then the shipping employee takes the next article 10 from placement area 61, in a step S03. Otherwise, the employee receives an instruction that the packaging process is concluded, and in a step S22 the employee can close the transport container 40. In a final step S23, the shipping employee terminates the method by confirmation at a user interface of electronic control device 50.

In a second exemplary embodiment of the method, cameras 21-24 of camera system 20 each have computing devices 51 to 54. These computing devices have filters and image stabilization systems.

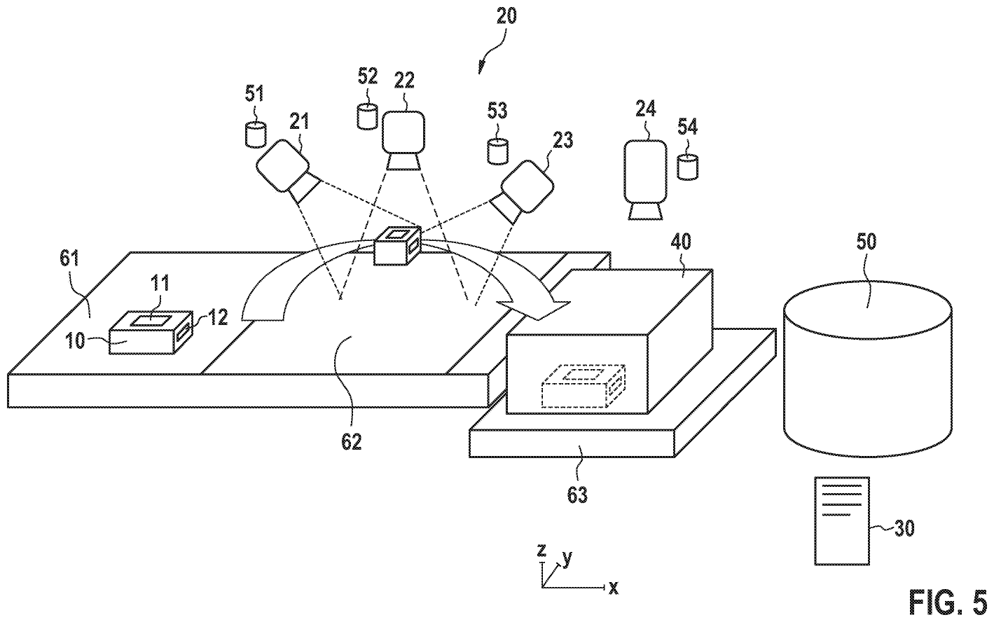

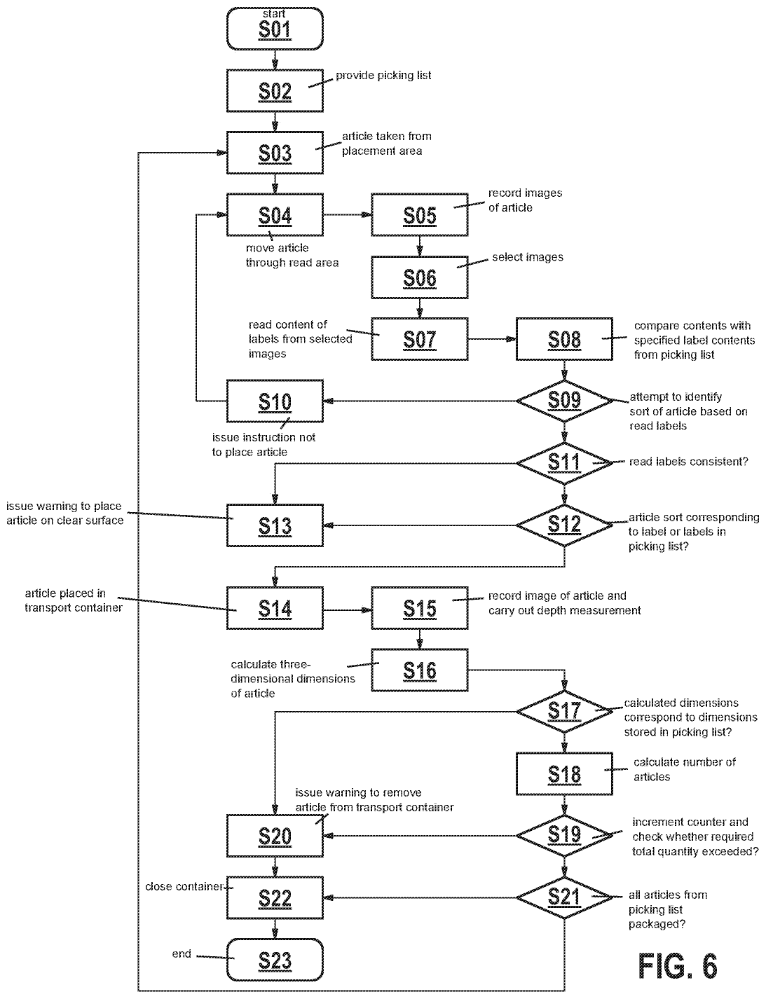

This is shown in FIG. 5. Here, the sequence of the method changes as shown in FIG. 6. Steps S06 and S07 are now no longer carried out in electronic control device 50, but rather in computing devices 51 to 53 of the first three cameras 21 to 23. Here, further information, such as timestamp, copyright, hash value, and image name, is also stored in image data files. Step S16 is also no longer carried out in electronic control device 50, but rather is carried out externally, in computing device 54 of fourth camera 24. Because steps S06, S07, and S16 are already carried out in camera system 20, the load on the network (not shown) between camera system 20 and electronic control device 50 is reduced.

1-14. (canceled)

15. A method for monitoring a picking or packaging process of at least one article, comprising the following steps:
a) recording, by a plurality of cameras, images of at least one moving article;
b) reading labels in the images;
c) comparing the read labels with specifications from a picking list;
d) identifying a sort of the article based on the comparison; and
e) issuing a warning based on sort of the article not agreeing with the specifications from the picking list.

16. The method as recited in claim 15, wherein between steps a and b, a selection is made of all images that contain at least one label and have at least a specified image quality level, and step b is carried out only with the selected images.

17. The method as recited in claim 15, further comprising the following step:
issuing a warning based on, in step c, recognizing that the read labels correspond to different sorts of articles according to the picking list.

18. The method as recited in claims 15, wherein in the picking list, essential labels are marked, the method further comprising the following step:
issuing a warning based on, in step b, not finding an essential label that would be expected for the sort of article identified in step d.

19. The method as recited in claim 15, further comprising the following steps:
f) recording at least one image and at least one depth measurement of the article after the article is placed in a transport container;
g) calculating three-dimensional dimensions of the article;
h) comparing the calculated dimensions with the specifications from the picking list for the sort of article identified in step d; and
i) issuing a warning based on the calculated dimensions of the article not agreeing with one or more of the specifications from the picking list.

20. The method as recited in claim 19, wherein a number of articles is inferred from the comparison of the calculated dimensions with the specifications from the picking list.

21. The method as recited in claim 20, further comprising the following step:
issuing warning based on the number of articles of the same sort acquired in the method exceeds a specification from the picking list.

22. A non-transitory machine-readable storage medium on which is stored a computer program for monitoring a picking or packaging process of at least one article, the computer program, when executed by a computer, causing the computer to perform:
comparing read labels with specifications from a picking list, the labels having been read from images of at least one moving article;
identifying a sort of the article based on the comparison; and
issuing a warning based on sort of the article not agreeing with the specifications from the picking list.

23. The non-transitory machine-readable storage medium as recited in claim 22, wherein the computer program, when executed by the computer, further causes the computer to perform:
comparing calculated dimensions of the article with the specifications from the picking list for the sort of article that was identified; and
issuing a warning based on the calculated dimensions of the article not agreeing with one or more of the specifications from the picking list.

24. A camera system, comprising:
a plurality of cameras configured to record images of at least one moving article, and reading labels in the images.

25. The camera system as recited in claim 24, further comprising:
at least one camera that has a depth sensor, configured to record at least one image and at least one depth measurement of the article after the article is placed in a transport container, and calculate three-dimensional dimensions of the article.

26. An electronic control device configured to to monitor a picking or packaging process of at least one article, the electronic control device configured to:
a) record, using a plurality of cameras, images of at least one moving article;
b) read labels in the images;
c) compare the read labels with specifications from a picking list;
d) identify a sort of the article based on the comparison; and
e) issue a warning based on sort of the article not agreeing with the specifications from the picking list.

27. A monitoring system for monitoring a picking or packaging process of at least one article, comprising:
a camera system including a plurality of cameras; and
an electronic control device configured to:
a) record, using the camera system, images of at least one moving article;
b) read labels in the images;
c) compare the read labels with specifications from a picking list;
d) identify a sort of the article based on the comparison; and
e) issue a warning based on sort of the article not agreeing with the specifications from the picking list.
